(19) United States
(12) Patent Application Publication
(10) Pub. No.: US 2024/0211976 A1
(43) Pub. Date: Jun. 27, 2024

(54) STORE OPERATION SUPPORT DEVICE, AND STORE OPERATION SUPPORT METHOD

(71) Applicant: Panasonic Intellectual Property Management Co., Ltd., Osaka (JP)

(72) Inventor: Tatsuya ISHIBASHI, Kanagawa (JP)

(73) Assignee: Panasonic Intellectual Property Management Co., Ltd., Osaka (JP)

(21) Appl. No.: 18/567,614

(22) PCT Filed: May 24, 2022
(86) PCT No.: PCT/JP2022/021269

§ 371 Date: Dec. 6, 2023

(30) Foreign Application Priority Data
Jun. 11, 2021 (JP) 2021-097760

(51) Int. Cl. G06Q 30/0201; G06V 40/10; G06V 40/20

(52) U.S. Cl. CPC G06Q 30/0201; G06V 40/103; G06V 40/20

(57) ABSTRACT

An analysis server performs, based on camera images of persons staying in front of exhibition areas in a store, an analysis regarding a merchandise evaluation state of the persons and presents a result of the analysis to a user. Specifically, the analysis server detects persons from the camera images and identifies persons to be analyzed, detects behaviors of the persons from the camera images, acquires behavior information of each person to be analyzed, in association with merchandise items, and accumulates the behavior information of each person in a storage, generates, based on the behavior information accumulated in the storage, merchandise evaluation information including at least a time needed for evaluation of each merchandise item, and accumulates the merchandise evaluation information for each person in the storage, and acquires, based on the merchandise evaluation information accumulated in the storage, an analysis result in which the merchandise evaluation state corresponding to each merchandise item is visualized.

### TECHNICAL FIELD

The present disclosure relates to a store operation support device and a store operation support method for supporting a store operation work of a user by performing, based on camera images of persons staying in front of exhibition areas in a store, an analysis regarding the merchandise evaluation state of the persons, and presenting the analysis result to the user.

### BACKGROUND ART

In a store, when purchasing merchandise items, customers in front of exhibition shelves perform evaluation of the merchandise items. If an analysis regarding such a merchandise evaluation state of customers is performed, it is possible to present information useful to consider improvement measures regarding inventory management or store layout to the user (a store manager or the like) and thereby to support the user's work.

As a technology related to such an analysis regarding the merchandise evaluation state of customers in the store, there is conventionally known a technology which detects, based on the camera images of the exhibition shelfs, “a change caused by placing a merchandise item on the merchandise shelf” or “a change caused by shifting the position of a merchandise item that has been placed on the merchandise shelf,” identifies a merchandise item that a customer was interested in but did not purchase, and acquires the frequency at which a customer was interested in but did not purchase a merchandise item (see Patent Document 1).

### PRIOR ART DOCUMENT(S)

### Patent Document(s)

[Patent Document 1] WO2019/171574A1

### SUMMARY OF THE INVENTION

### Task to be Accomplished by the Invention

However, the conventional technology focuses on only the frequency at which a customer was interested in but did not purchase a merchandise item. Therefore, the user cannot sufficiently grasp the merchandise evaluation state of customers, specifically, a degree of undecidedness of customers in merchandise evaluation. Therefore, there is a problem that the user cannot promptly take effective measures or the like for store operation improvement based on the presented information.

Thus, a primary object of the present disclosure is to provide a store operation support device and a store operation support method for enabling a user to sufficiently grasp the merchandise evaluation state of customers and to promptly take effective measures or the like for improvement of the store operation.

### Means to Accomplish the Task

A store operation support device of the present disclosure is a store operation support device provided with a processor which executes a process of performing, based on camera images of persons staying in front of exhibition areas in a store, an analysis regarding a merchandise evaluation state of the persons and presenting a result of the analysis to a user, wherein the processor detects persons from the camera images and identifies persons to be analyzed, detects behaviors of the persons from the camera images, acquires behavior information of each person to be analyzed, in association with merchandise items, and accumulates the behavior information of each person in a storage, generates, based on the behavior information accumulated in the storage, the merchandise evaluation information including at least a time needed for evaluation of each merchandise item, and accumulates the merchandise evaluation information for each person in the storage, and acquires, based on the merchandise evaluation information accumulated in the storage, an analysis result in which the merchandise evaluation state corresponding to each merchandise item is visualized.

Also, a store operation support method of the present disclosure is a store operation support method for causing an information processing device to execute a process of performing, based on camera images of persons staying in front of exhibition areas in a store, an analysis regarding a merchandise evaluation state of the persons and presenting a result of the analysis to a user, the method comprising: detecting persons from the camera images and identifying persons to be analyzed; detecting behaviors of the persons from the camera images, acquiring behavior information of each person to be analyzed, in association with merchandise items, and accumulating the behavior information of each person in a storage; generating, based on the behavior information accumulated in the storage, merchandise evaluation information including at least a time needed for evaluation of each merchandise item, and accumulating the merchandise evaluation information for each person in the storage; and acquiring, based on the merchandise evaluation information accumulated in the storage, an analysis result in which the merchandise evaluation state corresponding to each merchandise item is visualized.

### Effect of the Invention

According to the present disclosure, based on the merchandise evaluation information including the time needed for evaluation of each merchandise item, an analysis result in which the merchandise evaluation state corresponding to each merchandise item is visualized is acquired, and the analysis result is presented to the user. Therefore, the user can sufficiently grasp the merchandise evaluation state of customers and can promptly take effective measures or the like for improvement of the store operation.

### BRIEF DESCRIPTION OF THE DRAWINGS

FIG. 1 is an overall configuration diagram of a store operation support system according to the present embodiment;

FIG. 2 is an explanatory diagram showing a state of transition of camera images when the customer performs merchandise evaluation;

FIG. 3 is a block diagram showing a schematic configuration of an analysis server;

FIG. 4 is an explanatory diagram showing a registration content of a camera image database managed by the analysis server;

FIG. 5 is an explanatory diagram showing a registration content of a behavior information database managed by the analysis server;

FIG. 6 is an explanatory diagram showing a registration content of an undecidedness level information database managed by the analysis server;

FIG. 7 is a flowchart showing a procedure of a person identification process performed by the analysis server;

FIG. 8 is a flowchart showing a procedure of a behavior detection process performed by the analysis server;

FIG. 9 is a flowchart showing a procedure of an undecidedness level estimation process performed by the analysis server;

FIG. 10 is an explanatory diagram showing an in-store map screen displayed on a browser terminal; and

FIG. 11 is an explanatory diagram showing a camera image screen displayed on the browser terminal.

### MODE(S) FOR CARRYING OUT THE INVENTION

A first aspect of the invention made to accomplish the task is a store operation support device provided with a processor which executes a process of performing, based on camera images of persons staying in front of exhibition areas in a store, an analysis regarding a merchandise evaluation state of the persons and presenting a result of the analysis to a user, wherein the processor detects persons from the camera images and identifies persons to be analyzed, detects behaviors of the persons from the camera images, acquires behavior information of each person to be analyzed, in association with merchandise items, and accumulates the behavior information of each person in a storage, generates, based on the behavior information accumulated in the storage, the merchandise evaluation information including at least a time needed for evaluation of each merchandise item, and accumulates the merchandise evaluation information for each person in the storage, and acquires, based on the merchandise evaluation information accumulated in the storage, an analysis result in which the merchandise evaluation state corresponding to each merchandise item is visualized.

According to this, based on the merchandise evaluation information including the time needed for evaluation of each merchandise item, an analysis result in which the merchandise evaluation state corresponding to each merchandise item is visualized is acquired, and the analysis result is presented to the user. Therefore, the user can sufficiently grasp the merchandise evaluation state of customers and can promptly take effective measures or the like for improvement of the store operation.

In a second aspect of the invention, when, based on feature information of a person detected from the camera image, the processor determines that the person is a store clerk, the processor excludes the person from an analysis target.

According to this, it is possible to prevent a store clerk who performs work such as putting out merchandise from being included in the analysis target, and thus, an appropriate analysis result can be obtained.

In a third aspect of the invention, the processor detects, as a behavior related to merchandise evaluation by each person, an item holding behavior and an item gazing behavior, and acquires the behavior information including a detection result thereof.

According to this, it is possible to properly acquire the merchandise evaluation information related to the merchandise evaluation state of the persons based on the behavior information.

In a fourth aspect of the invention, the processor outputs the analysis result including a map image in which an image visualizing the merchandise evaluation information for each exhibition area is depicted on an image representing a layout in the store.

According to this, the user can immediately grasp the merchandise evaluation state of customers for each exhibition area. In this case, the map images at respective times may be played as a video.

In a fifth aspect of the invention, the processor outputs the analysis result including the camera image corresponding to the exhibition area selected by an operation of the user to select the exhibition area on a screen displaying the map image.

According to this, in relation to the exhibition area that the user paid attention to by viewing the map image, the user can concretely grasp the merchandise evaluation state of customers by viewing the camera images. In this case, the camera images at respective times may be played as a video.

In a sixth aspect of the invention, based on the behavior information, the processor acquires, as the merchandise evaluation information, a number of times of item holding, an item gazing time, and a number of held items, and, based on the number of times of item holding, the item gazing time, and the number of held items, acquires a merchandise evaluation degree which quantifies a degree of undecidedness of each person in merchandise evaluation.

According to this, with the merchandise evaluation degree (undecidedness level), the merchandise evaluation state of customers can be visualized by using a heat map or a graph. Therefore, the user can easily grasp the merchandise evaluation state of customers.

A seventh aspect of the invention is a store operation support method for causing an information processing device to execute a process of performing, based on camera images of persons staying in front of exhibition areas in a store, an analysis regarding a merchandise evaluation state of the persons and presenting a result of the analysis to a user, the method comprising: detecting persons from the camera images and identifying persons to be analyzed; detecting behaviors of the persons from the camera images, acquiring behavior information of each person to be analyzed, in association with merchandise items, and accumulating the behavior information of each person in a storage; generating, based on the behavior information accumulated in the storage, merchandise evaluation information including at least a time needed for evaluation of each merchandise item, and accumulating the merchandise evaluation information for each person in the storage; and acquiring, based on the merchandise evaluation information accumulated in the storage, an analysis result in which the merchandise evaluation state corresponding to each merchandise item is visualized.

According to this, as in the first aspect of the invention, the user can sufficiently grasp the merchandise evaluation state of customers and can promptly take effective measures or the like for improvement of the store operation.

In the following, an embodiment of the present disclosure will be described with reference to the drawings.

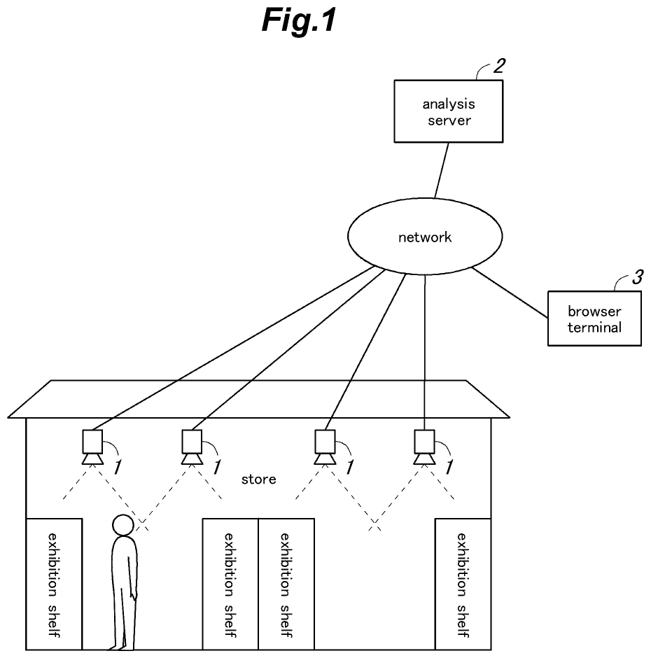

FIG. 1 is an overall configuration diagram of a store operation support system according to the present embodiment.

This store operation support system performs an analysis regarding a state of customers performing merchandise evaluation in front of exhibition shelves in a store, and presents the analysis result to the user (a store manager) to support the user's work. The store operation support system includes cameras 1, an analysis server 2 (a store operation support device, an information processing device), and a browser terminal 3. The cameras 1, the analysis server 2, and the browser terminal 3 are connected via a network.

The cameras 1 are installed in appropriate positions in the store. The cameras 1 capture images of exhibition shelves (exhibition areas) in the store and passages (stay areas) in front of them where customers may stay for merchandise evaluation.

The analysis server 2 performs analysis regarding the state of merchandise evaluation by the customers in the store. The analysis server 2 is constituted of a PC or the like. Note that other than being installed in the store, the analysis server 2 may be a cloud computer.

The browser terminal 3 is a terminal with which the user (a store manager or the like) views the analysis result of the analysis server 2. The browser terminal 3 is constituted of a PC, a tablet terminal, or the like.

Here, in the present embodiment, the analysis regarding the merchandise evaluation state of customers is performed for each of exhibition areas (exhibition shelves) corresponding to merchandise categories (noodles, rice balls, etc.). On the other hand, each camera 1 captures images of the exhibition area of a target merchandise category. Thus, based on the camera images, the analysis server 2 can perform the analysis regarding the merchandise evaluation state of customers for each exhibition area (merchandise category). Note that a single camera 1 may be configured to capture images of multiple exhibition areas, and the captured images of each exhibition area may be extracted from the camera images obtained by the camera 1.

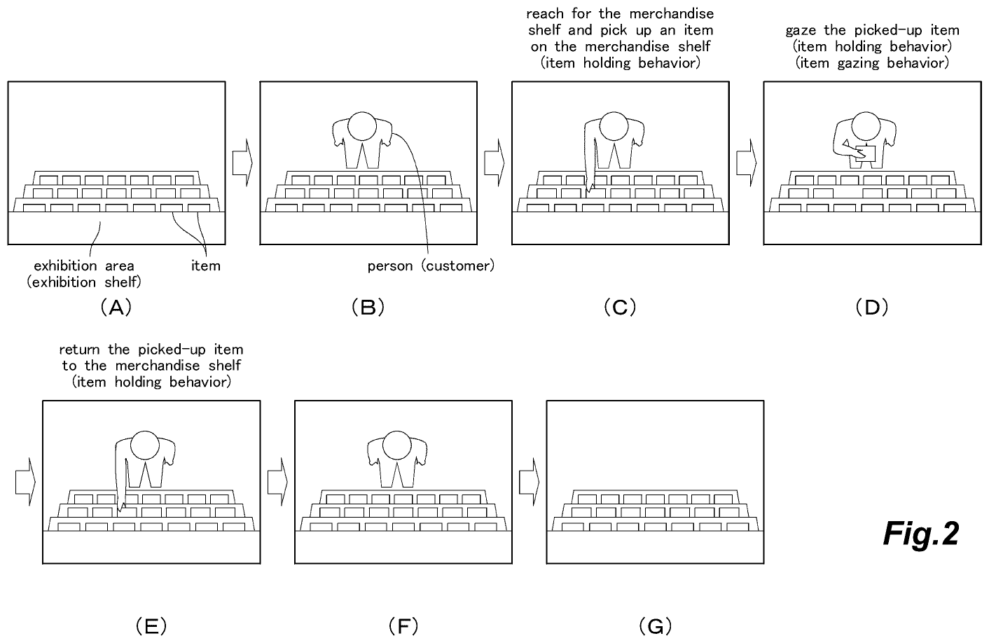

Next, the behavior of a customer in front of an exhibition shelf in the store will be described. FIG. 2 is an explanatory diagram showing a state of transition of camera images when a customer performs merchandise evaluation.

The camera 1 captures images, from above, of the exhibition shelf (exhibition area) and the passage (stay area) in front of it where the customer stays for merchandise evaluation. In the camera images, the merchandise items on the exhibition shelf and the person (customer) performing merchandise evaluation in front of the exhibition shelf are included. Note that the camera 1 may be placed to capture images of the exhibition shelf and the person from a side. Also, the camera 1 periodically transmits the camera images (frames) at respective times, which are captured at a predetermined frame rate, to the analysis server 2.

Here, a case where the person did not purchase a merchandise item is described. In this case, first, as shown in FIGS. 2(A) and 2(B), a person appears in front of the exhibition shelf. Next, as shown in FIG. 2(C), the person reaches for the merchandise shelf and picks up a merchandise item on the merchandise shelf. Next, as shown in FIG. 2(D), the person gazes at the picked-up merchandise item. Next, as shown in FIG. 2(E), the person returns the picked-up merchandise item to the merchandise shelf. Next, as shown in FIGS. 2 (F) and 2(G), the person disappears from the front of the exhibition shelf.

On the other hand, in the case where the person purchased the merchandise item, after gazing at the picked-up merchandise item as shown in FIG. 2(D), the person disappears from the front of the exhibition shelf as shown in FIG. 2(G) without returning the picked-up merchandise item to the merchandise shelf. Therefore, when the behavior of the person to return the picked-up merchandise item to the merchandise shelf cannot be detected, it can be determined that the person purchased the merchandise item.

Also, in the present embodiment, as behaviors related to merchandise evaluation by the customer, an item holding behavior and an item gazing behavior are detected. As shown in FIGS. 2(C), 2(D), and 2(E), the item holding behavior is a behavior of a person holding a merchandise item in the hand. Based on the detection state of this item holding behavior, it is possible to detect the person picking up a merchandise item on the merchandise shelf and returning the picked-up merchandise item to the merchandise shelf. As shown in FIG. 2(D), the item gazing behavior is a behavior of a person gazing at a merchandise item. The duration time of this item gazing behavior (item gazing time) is a time needed for evaluation of the merchandise item and represents a degree of undecidedness of the customer in merchandise evaluation, and it is estimated that the longer the gazing time is, the more undecided the customer is in merchandise evaluation.

Note that in the present embodiment, an example in which merchandise items are exhibited on an exhibition shelf will be described, but the store furniture on which the merchandise items are exhibited is not limited to the exhibition shelf. For example, other than the exhibition shelf, the merchandise items may be exhibited on an exhibition table (wagon), etc.

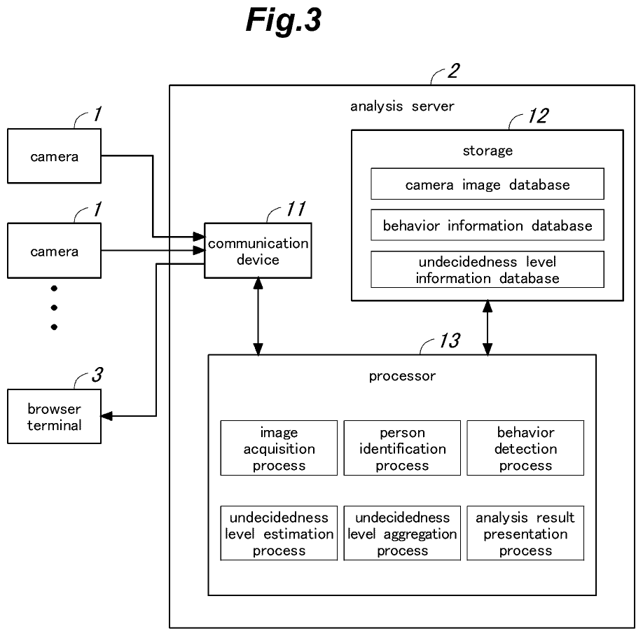

Next, a schematic configuration of the analysis server 2 will be described. FIG. 3 is a block diagram showing the schematic configuration of the analysis server 2.

The analysis server 2 is provided with a communication device 11, a storage 12, and a processor 13.

The communication device 11 performs communication with the cameras 1 and the browser terminal 3.

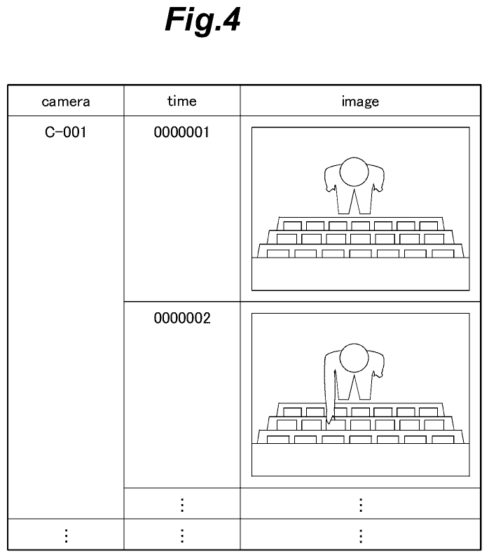

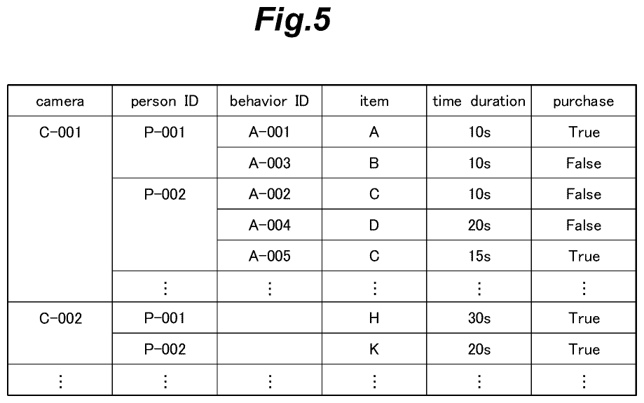

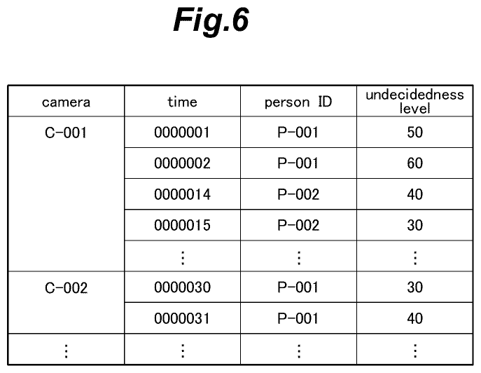

The storage 12 stores programs executed by the processor 13 and the like. Also, the storage 12 stores registration information of a camera image database (see FIG. 4), registration information of a behavior information database (see FIG. 5), and registration information of an undecidedness level information database (see FIG. 6).

The processor 13 performs various processes by executing the programs stored in the storage 12. In the present embodiment, the processor 13 performs an image acquisition process, a person identification process, a behavior detection process, an undecidedness level estimation process, an undecidedness level aggregation process, an analysis result presentation process, etc.

In the image acquisition process, the processor 13 acquires the camera images received from the cameras 1 by the communication device 11. These camera images are registered in the camera image database (see FIG. 4) in association with IDs of the cameras 1 and image capture times.

In the person identification process, the processor 13 identifies, based on the camera images, persons to be analyzed. At this time, the processor 13 first detects a person from the camera images (person detection process), and when the person is determined not to be a store clerk, namely, determined to be a customer, based on the feature information of the person, the processor 13 assigns a person ID to the person to indicate that the person is an analysis target. On the other hand, when the detected person is a store clerk, the person is excluded from the analysis target (detection result) (store clerk exclusion process). Also, when it is determined, based on the feature information of the person extracted from the camera images, that the person is the same as a previously detected person, the processor 13 performs a process of associating the person with the previously detected person (person tracking process).

In the behavior detection process, in relation to each person who has been determined to be an analysis target in the person identification process, the processor 13 detects a behavior of the person from the camera images (frames) at respective times. As a result of the behavior detection process, the behavior information of each person at each camera is registered in the behavior information database (see FIG. 5).

Here, in the present embodiment, the processor 13 detects, as behaviors related to merchandise evaluation by the customer, a behavior of a person holding a merchandise item in the hand (item holding behavior) and a behavior of a person gazing at a merchandise item (item gazing behavior).

In addition, here, the processor 13 correlates behaviors detected from camera images (frames) at respective times as a series of behaviors by the same person (behavior tracking process). Specifically, when a behavior of a person is newly detected from a camera image, a new behavior ID is assigned to the behavior, and a series of behaviors by the same person detected from subsequent camera images is assigned the same behavior ID.

In addition, here, the processor 13 detects, from the camera images, the merchandise item picked up by the person, and identifies the name of the merchandise item by image recognition (merchandise item detection process).

In addition, here, the processor 13 measures the duration time of the item gazing behavior of the person, and thereby acquires the time for which the person gazed at the merchandise item (item gazing time) (gazing time measurement process). Specifically, the item gazing time is measured based on the number of camera images (frames) in which the item gazing behavior was detected and the time of one cycle corresponding to the camera image interval (frame interval).

In addition, here, at the end of the tracking period of each person (the period from when the person entered the capture range of the camera 1 to when the person exited the capture range), the processor 13 determines whether a purchase was made or not (purchase determination process). At this time, by tracking the item holding behavior of the person, whether the merchandise item picked up by the person was returned to the merchandise shelf is detected, and based on the result thereof, it is determined whether a purchase was made or not. Note that it may be determined that a purchase was made when the person disappeared from the front of the exhibition shelf without returning the picked-up merchandise item to the exhibition shelf, but it may be also possible to detect a behavior of the person putting the picked-up merchandise item in a basket.

In the undecidedness level estimation process, based on the behavior information, which is the detection result of the behavior detection process and is registered in the behavior information database (see FIG. 5), the processor 13 estimates an undecidedness level of each person at each time in each exhibition area. As a result of the undecidedness level estimation process, the undecidedness level of each person at each time at each of the cameras 1 which correspond to the respective exhibition areas is registered in the undecidedness level information database (see FIG. 6).

The undecidedness level (merchandise evaluation degree) quantifies the degree of undecidedness of a person in merchandise evaluation when purchasing merchandise. In the present embodiment, the number of times of item holding, the item gazing time, and the number of held items are acquired for each person, and based on the number of times of item holding, the item gazing time, and the number of held items, the undecidedness level of each person is calculated according to the following formula.

undecidedness level=λ₁×item gazing time (seconds)+λ₂×number of times of item holding (times)+λ₃×number of held items (pieces)

For example, in a case where the coefficients are set such that λ₁=1, λ₂=5, and λ₃=10, and a person picked up each of two types of merchandise items one time, and gazed at them for 30 seconds in total, the undecidedness level is calculated as 1×30+5×2+10×2=60.

Here, the number of times of item holding is the number of times of performing the item holding behavior which is a behavior of a person picking up a merchandise item. The item gazing time is a duration time of the item gazing behavior which is a behavior of a person gazing at a merchandise item. The number of held items is the number of merchandise items subject to the item holding behavior which is a behavior of a person picking up a merchandise item. Note that duplication due to repeatedly picking up the same merchandise item is not counted.

In the undecidedness level aggregation process, the processor 13 aggregates the undecidedness level of each person at each time at each camera, which is acquired in the undecidedness level estimation process, and thereby calculates the undecidedness level at each time for each of the exhibition areas which correspond to the respective cameras.

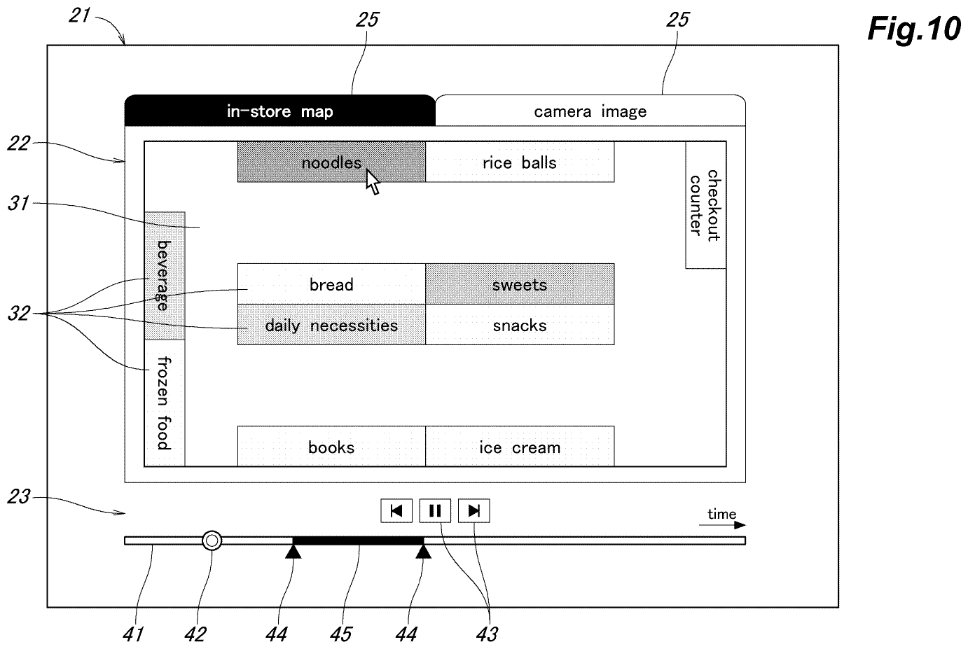

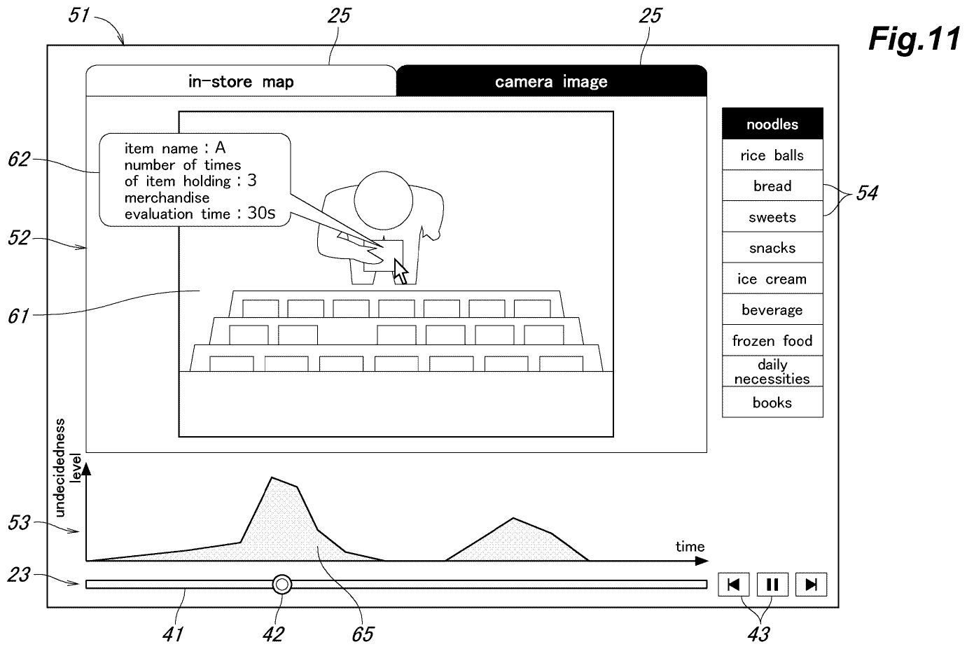

In the analysis result presentation process, the processor 13 presents the analysis result regarding the merchandise evaluation state of customers in the store to the user. Specifically, upon request from the browser terminal 3, the processor 13 causes an in-store map screen 21 (see FIG. 10), which includes an undecidedness level heat map that visualizes the undecidedness level at each time in each exhibition area acquired in the undecidedness level aggregation process, to be displayed on the browser terminal 3. Also, the processor 13 causes a camera image screen 51 (see FIG. 11), which includes a camera image of a selected exhibition area and an undecidedness level graph that visualizes the undecidedness level at each time in the selected exhibition area, to be displayed on the browser terminal 3.

Next, the camera image database managed by the analysis server 2 will be described. FIG. 4 is an explanatory diagram showing the registration content of the camera image database.

The analysis server 2 registers the camera images (frames) at respective times received from the cameras 1 in the camera image database and manages them. In the camera image database, each camera image is registered in association with the name (camera ID) of the camera 1 and the image capture time.

Next, the behavior information database managed by the analysis server 2 will be described. FIG. 5 is an explanatory diagram showing the registration content of the behavior information database.

In the analysis server 2, a process of detecting behaviors of persons from the camera images (frames) at respective times is performed (behavior detection process), and the result of this behavior detection process, namely, the behavior information of each person at each camera, is registered in the behavior information database.

In the behavior information database, as the behavior information of each person, the name (camera ID) of the camera 1 corresponding to the exhibition area, the person ID, the behavior ID, the name of the merchandise item (merchandise ID), the item gazing time, and purchase (True) and non-purchase (False) as the purchase state information (information related to whether a purchase was made or not) are registered.

Here, in the behavior detection process, a behavior ID is assigned to a series of behaviors of a person picking up a merchandise item and returning it, or picking up a merchandise item and leaving from the front of the exhibition shelf without returning it. Therefore, when a person performs a behavior of picking up a merchandise item and returning it at one exhibition area multiple times, they are detected as separate behaviors, and different behavior IDs are assigned irrespective of whether the merchandise items picked up by the person are different or the merchandise items are the same.

Next, the undecidedness level information database managed by the analysis server 2 will be described. FIG. 6 is an explanatory diagram showing the registration content of the undecidedness level information database.

In the analysis server 2, a process of estimating the undecidedness level of each person (undecidedness level estimation process) is performed, and the result of this undecidedness level estimation process, namely, the undecidedness level of each person at each time at each of the cameras 1 which correspond to the respective exhibition areas, is registered in the undecidedness level information database.

In the undecidedness level information database, as the undecidedness level information of each person, the name (camera ID) of the camera 1, the estimation time, the person ID, and the undecidedness level are registered.

Here, in the undecidedness level estimation process, a process of estimating the undecidedness level of each person is performed periodically. Therefore, as the time period for which the person gazes at the merchandise item for merchandise evaluation (duration time of the item gazing behavior) becomes longer, the value of the undecidedness level at each time related to the person gradually becomes greater.

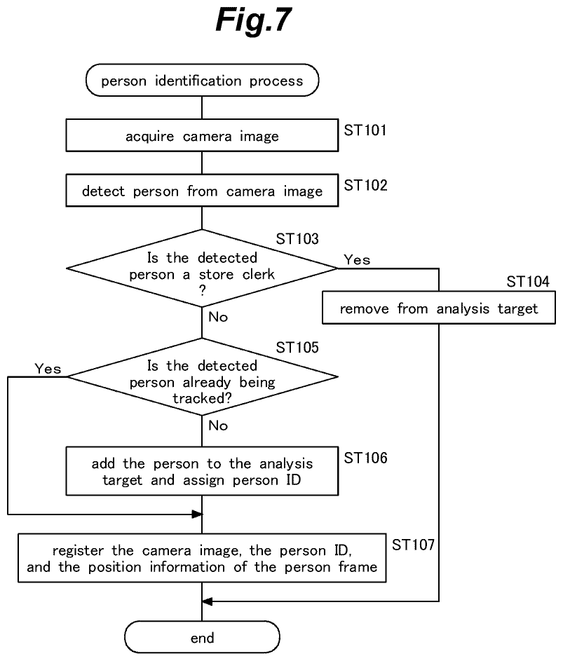

Next, the person identification process performed by the analysis server 2 will be described. FIG. 7 is a flowchart showing the procedure of the person identification process performed by the analysis server 2.

In the analysis server 2, a process of identifying, based on the camera images, persons to be analyzed (person identification process) is performed. In this person identification process, the flow shown in FIG. 7 is executed every time a camera image (frame), which is periodically transmitted from each camera 1, is received.

First, the processor 13 acquires the camera image received from the camera 1 by the communication device 11 (image acquisition process) (ST101).

Next, the processor 13 detects a person from the camera image (person detection process) (ST102). At this time, a rectangular person frame (person region) surrounding the person is set on the camera image, and the position information of the person frame on the camera image is acquired.

Next, the processor 13 determines whether the person detected from the camera image is a store clerk (ST103). At this time, it is possible to determine whether the person is a store clerk based on clothing features. Specifically, it is possible to determine whether the person is a store clerk depending on whether the person is wearing a store uniform. Note that since a store clerk performs work such as putting out merchandise in front of the exhibition shelf, a store clerk may be erroneously recognized as a customer evaluating the merchandise in front of the exhibition shelf evaluation.

Here, when the person detected from the camera image is a store clerk (Yes in ST103), the person is excluded from the analysis target (detection result) (store clerk exclusion process) (ST104). Then, the process for the present camera image (frame) is ended.

On the other hand, when the person detected from the camera image is not a store clerk, namely, when the person is a customer (No in ST103), then, the processor 13 determines whether the person detected from the camera image is already being tracked (ST105). Note that in the case where there are multiple persons in the camera image, if persons who are not store clerks (namely, who are customers) are detected, the process of ST105 is performed for each of these persons.

Here, in the case where the person detected from the camera image is not being tracked yet, namely, in the case where the person is first detected in the present camera image (No in ST105), the person is added to the tracking target, and a person ID is assigned to the person (ST106).

Subsequently, the processor 13 registers the present camera image in the camera image database (see FIG. 4) in association with the camera ID and the image capture time. Also, the processor 13 adds the detection result related to the present camera image, namely, the position information of the person frame on the camera image, to the person tracking information, in association with the person ID (ST107).

On the other hand, when the person detected from the camera image is already being tracked (Yes in ST105), the process of ST106 is skipped.

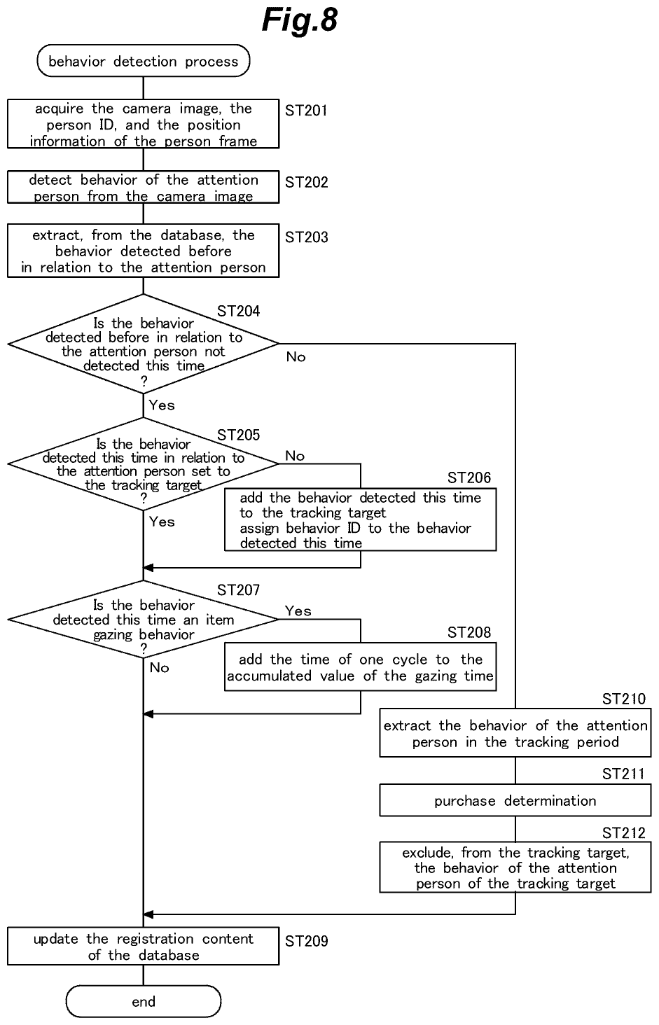

Next, the behavior detection process performed by the analysis server 2 will be described. FIG. 8 is a flowchart showing a procedure of the behavior detection process performed by the analysis server 2.

In the analysis server 2, a process of detecting a behavior of the customer performing merchandise evaluation in front of the exhibition shelf (behavior detection process) is performed based on the camera images received from the camera 1. In this behavior detection process, the flow shown in FIG. 8 is executed every time a camera image (frame), which is periodically transmitted from the camera 1, is received.

First, the processor 13 sets the person detected from the present camera image as an attention person, and acquires the present camera image (frame) in which the attention person appears, the person ID, and the position information of the person frame on the present camera image (ST201).

Then, the processor 13 executes a predetermined behavior recognition process on the whole image in which the attention person is included, and thereby detects a behavior of the attention person, such as an item holding behavior, an item gazing behavior, or the like (ST202).

Next, the processor 13 extracts, from the behavior information database, the behavior information related to the behavior detected before in relation to the attention person and set to the tracking target (ST203).

Next, the processor 13 compares the behavior detected this time in relation to the attention person and the behavior detected before in relation to the attention person, and thereby determines whether the behavior detected before in relation to the attention person is not detected this time (ST204).

Here, when the behavior detected before in relation to the attention person is detected this time also (Yes in ST204), then, the processor 13 determines whether the behavior detected this time in relation to the attention person is already set to the tracking target (ST205).

Here, when the behavior detected this time in relation to the attention person has not been set to the tracking target yet (No in ST205), the behavior detected this time in relation to the attention person is added to the tracking target, and the behavior detected this time is assigned a behavior ID (ST206).

Subsequently, the processor 13 determines whether the behavior detected this time in relation to the attention person is an item gazing behavior (ST207).

Here, when the behavior detected this time in relation to the attention person is an item gazing behavior (Yes in ST207), the time of one cycle corresponding to the camera image interval (frame interval) is added to the accumulated value of the gazing time related to the behavior (ST208). Here, the accumulated value of the gazing time is updated so that every time an item gazing behavior is detected from the camera image (frame), the time of one cycle is added.

Next, the processor 13 updates the registration content of the behavior information database (ST209). At this time, when the behavior of the target person detected this time is an item gazing behavior, the gazing time added this time in relation to the behavior is registered in the behavior information database (see FIG. 5).

On the other hand, when the behavior detected before in relation to the attention person is not detected this time (No in ST204), then, the processor 13 fixes the tracking period related to the behavior of the attention person, and extracts the detection result related to the camera images included in the tracking period, namely, the behavior information (which corresponds to the behavior ID) of the attention person included in the tracking period (ST210).

Next, the processor 13 determines, based on the behavior information (which corresponds to the behavior ID) of the attention person included in the tracking period, whether the target person purchased the merchandise (purchase determination process) (ST211). At this time, when it is detected that the target person returned the merchandise item to the exhibition shelf, it is determined that a purchase was not made. On the other hand, when it is detected that the target person put a merchandise item in the basket or when the target person left the exhibition shelf while holding a merchandise item, it is determined that a purchase was made.

Then, the processor 13 excludes, from the tracking target, the behavior set to the tracking target in relation to the attention person (ST212).

Subsequently, the processor 13 updates the registration content of the behavior information database (ST209). At this time, the determination result of the purchase determination process, namely, information on the purchase state (where a purchase was made or not) is registered in the behavior information database (see FIG. 5).

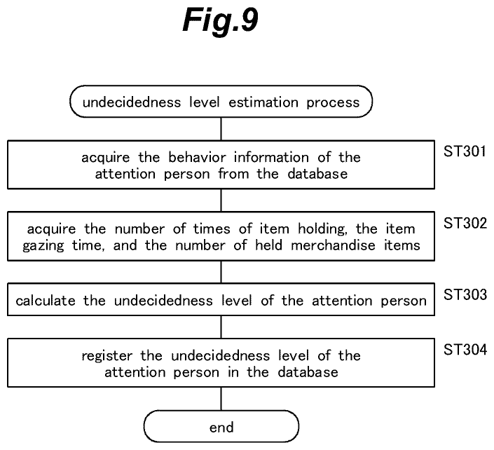

Next, the undecidedness level estimation process performed by the analysis server 2 will be described. FIG. 9 is a flowchart showing the procedure of the undecidedness level estimation process performed by the analysis server 2.

In the analysis server 2, based on the behavior information of each person registered in the behavior information database (see FIG. 5) by the behavior detection process (see FIG. 8), a process of estimating the undecidedness level of each person (undecidedness level estimation process) is performed. In this undecidedness level estimation process, the flow shown in FIG. 9 is repeated for each person for which a behavior was detected in the behavior detection process, namely, for each person for which the person ID is registered in the behavior information database.

First, the processor 13 acquires the behavior information related to the attention person from the behavior information database (see FIG. 5) (ST301).

Then, based on the behavior information related to the attention person, the processor 13 acquires the number of times of item holding, the item gazing time, and the number of held items (ST302).

Then, the processor 13 calculates the undecidedness level related to the attention person based on the number of times of item holding, the item gazing time, and the number of held items (ST303).

Then, the processor 13 registers the undecidedness level related to the attention person in the undecidedness level information database (see FIG. 6) together with the camera name, the current time, and the person ID (ST304).

Next, the in-store map screen 21 displayed on the browser terminal 3 will be described. FIG. 10 is an explanatory diagram showing the in-store map screen 21 displayed on the browser terminal 3.

On the browser terminal 3, the in-store map screen 21 in which the merchandise evaluation state of customers is visualized for each exhibition area (exhibition shelf) is displayed for presentation to the user.

The in-store map screen 21 is provided with a map display part 22. In the map display part 22, an undecidedness level heat map 31 (map image) in which the height of the undecidedness level (merchandise evaluation state) for each exhibition area is visualized is displayed on the in-store map representing the layout in the store.

Specifically, in the undecidedness level heat map 31, exhibition area images 32 representing exhibition areas (exhibition shelves) for the respective merchandise categories (noodles, rice balls, etc.) are drawn, and the display form of each exhibition area image 32 changes according to the height of the undecidedness level. In the example shown in FIG. 10, the height of the undecidedness level for each exhibition area is represented by a shade of color. The exhibition area image 32 related to an exhibition area with a high undecidedness level is highlighted in dark color.

As described above, in the present embodiment, the undecidedness level (the merchandise evaluation state) for each exhibition area is visualized in the undecidedness level heat map 31. Therefore, the user (a store manager or the like) can immediately grasp the undecidedness level (merchandise evaluation state) for each exhibition area. In the example shown in FIG. 10, the user can immediately grasp that the undecidedness level is the highest in the exhibition area of noodles.

Also, the in-store map screen 21 is provided with a play operation part 23. This play operation part 23 is provided with a slider 42 movable on a seek bar 41. The seek bar 41 corresponds to the opening hours (from the opening time to the closing time) per day of the target store. By operating the slider 42 to specify the play position (play time point), the user can cause the undecidedness level heat map 31 at an arbitrary time in the opening hours to be displayed.

Also, the undecidedness level heat map 31 is displayed as a video. The play operation part 23 is provided with a play button 43. By operating the play button 43, the user can play the undecidedness level heat map 31 as a video from the opening time or an arbitrary time specified with the slider 42. Thus, the user can immediately grasp the changing state of the undecidedness level of customers for each exhibition area.

Here, in the analysis server 2, the undecidedness level for each exhibition area is calculated by aggregating the undecidedness level of each person for each exhibition area (camera 1). At this time, an aggregation period of a predetermined length (for example, one minute) is set with respect to the display time. For example, an aggregation period of a predetermined length is set immediately before the display time. Then, the undecidedness level of each person included in the aggregation period is aggregated, so that the undecidedness level for exhibition area at the display time is calculated. Thereby, the aggregation period is shifted as the display time progresses, and therefore, the undecidedness level for each exhibition area changes along with the lapse of time, and in the undecidedness level heat map 31, the display state (for example, a shade of color) of each exhibition area image 32 changes in accordance with the change of the undecidedness level.

As described above, in the present embodiment, the undecidedness level heat map 31 is displayed as a video. Therefore, the user can immediately grasp the changing state of the undecidedness level of customers in each exhibition area.

Also, with the play operation part 23, the user can specify the analysis period on the seek bar 41. Specifically, the play operation part 23 is provided with two section-specifying buttons 44 to be movable along the seek bar 41. The two section-specifying buttons 44 correspond to the start point and the end point of the analysis period. By operating the section-specifying buttons 44, the user can specify an arbitrary period as the analysis period. At this time, a part 45 on the seek bar 41 corresponding to the analysis period is displayed with highlight.

When the analysis period is specified as above, the analysis is performed in the analysis server 2 based on the behavior information of the customers included in the specified analysis period, and the undecidedness level heat map 31 is displayed on the in-store map screen 21 as the analysis result thereof. Thus, the user can check the undecidedness level of customers while narrowing down the time range.

Further, the in-store map screen 21 is provided with tabs 25 for selecting the screen. By operating the tabs 25, the user can switch between the in-store map screen 21 (see FIG. 10) and the camera image screen 51 (see FIG. 11).

Next, the camera image screen 51 displayed on the browser terminal 3 will be described. FIG. 11 is an explanatory diagram showing the camera image screen 51 displayed on the browser terminal 3.

When an operation of selecting an exhibition area is performed on the in-store map screen 21 (see FIG. 10), the camera image screen 51 related to the selected exhibition area is displayed. Also, when the tab 25 of the camera image is operated on the in-store map screen 21, the screen transitions to the camera image screen 51.

The camera image screen 51 is provided with a camera image display part 52. In the camera image display part 52, a camera image 61 is displayed. Each camera 1 captures images, from above, of the exhibition area (exhibition shelf) and the area in front of it where customers may stay for merchandise evaluation. In the camera image 61, the merchandise items in the exhibition area and the customer picking up and seeing a merchandise item are shown. Therefore, by viewing the camera image 61, the user can visually and concretely check the actual merchandise evaluation state of customers.

Also, when the user performs an operation of selecting the person or merchandise item on the camera image 61, a speech balloon 62 (information display part) is displayed in the camera image display part 52. In this speech balloon 62, the name of the merchandise item picked up by the person, the number of times that the person picked up the merchandise item (the number of times of item holding), and the time for which the person is evaluating the merchandise item (item gazing time) are displayed. Note that configuration may be made such when the operation of selecting the merchandise item is performed, the name of the merchandise item is displayed in the speech balloon 62, and when the operation of selecting the person is performed, the person ID is displayed in the speech balloon 62.

Also, similarly to the in-store map screen 21 (see FIG. 10), the camera image screen 51 is provided with a play operation part 23. By performing an operation of moving the slider 42 along the seek bar 41, it is possible to display the camera image at a desired time in the play operation part 23. Also, by operating the play button 43, it is possible to play the camera images as a video from an arbitrary time.

Further, the camera image screen 51 is provided with a graph display part 53. In the graph display part 53, an undecidedness level graph 65 related to the exhibition area corresponding to the camera image is displayed. In the undecidedness level graph 65, the horizontal axis represents time, and the vertical axis represents the undecidedness level, so that the changing state of the undecidedness level along with the lapse of time is expressed. Thereby, the user can immediately grasp the changing state of the undecidedness level in the target exhibition area.

Also, the camera image screen 51 is provided with multiple area selection buttons 54 for the respective exhibition areas. When the user operates an area selection button 54, the screen transitions to the camera image screen 51 related to the exhibition area corresponding to the area selection button 54. Therefore, the user can easily switch the screen to the camera image screen 51 related to a desired exhibition area, and thereby can check the merchandise evaluation state of customers in the desired exhibition area.

As described above, in the present embodiment, the undecidedness level graph 65 representing the changing state of the undecidedness level is displayed, and thus, the user can immediately grasp the time when the undecidedness level is high. Also, by operating the play operation part 23 to display the camera image 61 at the time when the undecidedness level is high, the user can check the situation in which the customer is undecided, and can grasp whether or not the customer purchased the merchandise. Also, with the speech balloon 62 displayed on the camera image 61, the user can check the name of the merchandise item picked up by the customer or the like.

Thereby, the user can recognize whether the customer purchased the merchandise item after much consideration, for example. Here, in the case where the customer purchased the merchandise item after much consideration, it can be assumed that the customer decided the purchase after sufficiently comparing it with other merchandise, and thus, the merchandise item that the customer selected is considered better than the other merchandise. Thus, by exhibiting this merchandise item in a position that can be easily seen by many customers, it is possible to increase the sales. On the other hand, in the case where the customer did not purchase anything after much consideration, it can be assumed that if the store clerk provided support such as providing information about the merchandise item, the customer would have purchased the merchandise item. Thus, the user can consider ideas for sales promotion such as the timing of support provided by the store clerk to the customer or the like.

Note that in the in-store map screen 21 and the camera image screen 51, the merchandise evaluation state of customers is displayed in real time based on the behavior information of the customers of the day, but it is also possible to display the past merchandise evaluation state of customers in the in-store map screen 21 and the camera image screen 51. In this case, the user specifies the condition (the date, the day of the week, the period, etc.), and the in-store map screen 21 and the camera image screen 51 may be generated based on the past behavior information of customers so as to satisfy the condition.

In the foregoing, an embodiment has been described as an example of the technology disclosed in the present application. However, the technology in the present disclosure is not limited to this, and may be applied to embodiments in which change, replacement, addition, omission, etc. are made. Also, it is also possible to combine the components explained in the above embodiment to make new embodiments.

### INDUSTRIAL APPLICABILITY

The store operation support device and the store operation support method according to the present disclosure have effects that the user can sufficiently grasp the merchandise evaluation state of customers and can promptly take effective measures or the like for improvement of the store operation, and are useful as a store operation support device and a store operation support method which support the user's work by performing, based on a camera image of a person staying in front of an exhibition area in a store, an analysis regarding the merchandise evaluation state of the person, and presenting the analysis result to the user, or the like.

### LIST OF REFERENCE NUMERALS

1 camera
2 analysis server (store operation support device, information processing device)
3 browsing terminal
12 storage
13 processor
21 in-store map screen
23 play operation part
31 undecidedness level heat map
32 exhibition area image
41 seek bar
42 slider
43 play button
44 section-specifying button
part corresponding to analysis period
51 camera image screen
54 area selection button
61 camera image
62 speech balloon
65 undecidedness level graph

1. A store operation support device provided with a processor which executes a process of performing, based on camera images of persons staying in front of exhibition areas in a store, an analysis regarding a merchandise evaluation state of the persons and presenting a result of the analysis to a user,
wherein the processor
detects persons from the camera images and identifies persons to be analyzed,
detects behaviors of the persons from the camera images, acquires behavior information of each person to be analyzed, in association with merchandise items, and accumulates the behavior information of each person in a storage,
generates, based on the behavior information accumulated in the storage, the merchandise evaluation information including at least a time needed for evaluation of each merchandise item, and accumulates the merchandise evaluation information for each person in the storage, and
acquires, based on the merchandise evaluation information accumulated in the storage, an analysis result in which the merchandise evaluation state corresponding to each merchandise item is visualized.

2. The store operation support device according to claim 1, wherein when, based on feature information of a person detected from the camera image, the processor determines that the person is a store clerk, the processor excludes the person from an analysis target.

3. The store operation support device according to claim 1, wherein the processor detects, as a behavior related to merchandise evaluation by each person, an item holding behavior and an item gazing behavior, and acquires the behavior information including a detection result thereof.

4. The store operation support device according to claim 1, wherein the processor outputs the analysis result including a map image in which an image visualizing the merchandise evaluation information for each exhibition area is depicted on an image representing a layout in the store.

5. The store operation support device according to claim 4, wherein the processor outputs the analysis result including the camera image corresponding to the exhibition area selected by an operation of the user to select the exhibition area on a screen displaying the map image.

6. The store operation support device according to claim 1, wherein based on the behavior information, the processor acquires, as the merchandise evaluation information, a number of times of item holding, an item gazing time, and a number of held items, and, based on the number of times of item holding, the item gazing time, and the number of held items, acquires a merchandise evaluation degree which quantifies a degree of undecidedness of each person in merchandise evaluation.

7. A store operation support method for causing an information processing device to execute a process of performing, based on camera images of persons staying in front of exhibition areas in a store, an analysis regarding a merchandise evaluation state of the persons and presenting a result of the analysis to a user,
the method comprising:
detecting persons from the camera images and identifying persons to be analyzed;
detecting behaviors of the persons from the camera images, acquiring behavior information of each person to be analyzed, in association with merchandise items, and accumulating the behavior information of each person in a storage;
generating, based on the behavior information accumulated in the storage, merchandise evaluation information including at least a time needed for evaluation of each merchandise item, and accumulating the merchandise evaluation information for each person in the storage; and
acquiring, based on the merchandise evaluation information accumulated in the storage, an analysis result in which the merchandise evaluation state corresponding to each merchandise item is visualized.
